(19) United States
(12) Patent Application Publication
(10) Pub. No.: US 2015/0128071 A1
(43) Pub. Date: May 7, 2015

(54) SYSTEM AND METHOD FOR PROVIDING SOCIAL NETWORK SERVICE

(71) Applicant: NAVER CORPORATION, Seongnam-si (KR)

(72) Inventors: Byoung Seok Yang, Seongnam-si (KR); Seong Hyun Woo, Seongnam-si (KR)

(21) Appl. No.: 14/451,992

(22) Filed: Aug. 5, 2014

(30) Foreign Application Priority Data
Nov. 6, 2013 (KR) 10-2013-0134371

(51) Int. Cl. H04L 12/18; G06F 3/0484; G06F 3/0481

(52) U.S. Cl. CPC H04L 12/1813; G06F 3/0481; G06F 3/0484
USPC 715/753

(57) ABSTRACT

A method for providing a social network service (SNS) to share predetermined data between users who are acquaintances of each other includes transmitting music-matched photo data from one or more user terminals and registering the photo data in the service providing server. The music-matched photo data includes one or more of photo data matched to predetermined music transmitted from a user terminal of a user, photo data matched to predetermined music transmitted from user terminals of users who are acquaintances of the user, and photo data recommended a predetermined number of times or more or ranked in a predetermined place or higher in terms of recommendation among photo data registered as being matched to the predetermined music.

### RELATED APPLICATIONS

This application claims the benefit of Korean Patent Application No. 10-2013-0134371, filed on Nov. 6, 2013, in the Korean Intellectual Property Office, the disclosure of which is incorporated herein in its entirety by reference.

### BACKGROUND

One or more embodiments of the present invention relate to a system and method for providing a social network service (SNS), and more particularly, to a system and method for providing an SNS based on music and photos.

Information and communication technologies based on the Internet and mobile communication devices have changed the life patterns of modern people. With the spread of Personal Computers (PCs) that allow users to connect to the Internet in almost every school and office, information acquisition using web sites, product purchase via electronic commerce, and news exchange using e-mails have developed considerably. Several years ago, people could only use mobile communication services mainly focused on voice communication via mobile communication terminals. Recently, however, wireless Internet services have been provided through mobile communication terminals in order to provide users with data communication services via the Internet.

An SNS using wired/wireless Internet services has received much interest from the public. Such an SNS allows users to form a human network by using the Internet, and representative examples of an SNS are FACEBOOK (http://www.facebook.com/), TWITTER (http://twitter.com/), and CYWORLD (http://www.cyworld.com/).

The above-described background techniques correspond to technical information that the inventor(s) has to derived in the present disclosure or has acquired while deriving the present disclosure, and are not necessarily well-known arts disclosed to the public prior to filing the present application.

### SUMMARY

One or more embodiments of the present invention include a system and method for providing a social network service (SNS) based on music and photos.

Additional aspects will be set forth in part in the description which follows and, in part, will be apparent from the description, or may be learned by practice of the presented embodiments.

According to one or more embodiments of the present invention, a method for providing a social network service (SNS) to share predetermined data between users who are acquaintances with each other includes transmitting, by a service providing server, music-matched photo data from one or more user terminals and registering the photo data in the service providing server. The music-matched photo data registered in the service providing server includes one or more of: photo data matched to predetermined music transmitted from a user terminal of a user; photo data matched to predetermined music transmitted from user terminals of users who are acquaintances of the user; and photo data recommended a predetermined number of times or more or ranked in a predetermined place or higher in terms of recommendation among photo data registered as being matched to the predetermined music.

The method may further include providing one or more music-matched photo data to the user terminal during playback of music on the user terminal to display the photo data on the user terminal; or providing one or more posts including a photo recommended or registered by a user or an acquaintance of the user and information about music matched to the photo to the user terminal to display the posts on a timeline of the user terminal.

The displaying of the photo data during playback of the music may include sequentially displaying the multiple photos on the user terminal during playback of music, if the multiple photos matched to the music exist.

The multiple photos may be displayed in an order of the number of recommendations.

Photos recommended or registered by a user or an acquaintance of the user from among the multiple photos may be displayed.

The providing of one or more posts may include displaying the posts on the timeline in a time order of registration of posts.

If a timeline playback signal is input from the user terminal, music on the timeline may be played on the user terminal.

During playback of music on the user terminal, photos recommended or registered by a user or an acquaintance of the user from among the multiple photos may be displayed.

During playback of music on the user terminal, a currently displayed photo may be recommended.

During playback of music on the user terminal, photo data matched to the currently played music may be registered.

The photo data may be directly transmitted from the user terminal and registered in the service providing server, or link information of the photo may be transmitted from the user terminal and the link information of the photo or photo data downloaded using the link information of the photo is registered in the service providing server.

According to one or more embodiments of the present invention, a system for providing a social network service (SNS) to share predetermined data between users who are acquaintances with each other includes a music providing unit providing music data to be played on a user terminal; and a photo registering unit storing music-matched photo data transmitted from the user terminal in a database. The music-matched photo data registered in the service providing server comprises one or more of: photo data matched to predetermined music transmitted from a user terminal of a user; photo data matched to predetermined music transmitted from user terminals of users who are acquaintances of the user; and photo data recommended a predetermined number of times or more or ranked in a predetermined place or higher in terms of recommendation among photo data registered as being matched to the predetermined music.

The system may further include a timeline managing unit providing one or more posts including a photo recommended or registered by a user or an acquaintance of the user and information about music matched to the photo to the user terminal, or a photo providing unit providing one or more music-matched photo data to the user terminal during playback of music on the user terminal.

If multiple photos matched to music exist, the photo providing unit may provide the one or more photos to the user terminal during playback of the music to allow the multiple photos to be sequentially displayed on the user terminal.

The multiple photos may be displayed on the user terminal in an order of the number of recommendations.

Photos recommended or registered by a user or an acquaintance of the user among the multiple photos may be displayed on the user terminal.

The timeline managing unit may provide the one or more posts to the user terminal so that the one or more posts are displayed on the timeline in a time order of registration of posts.

If a timeline playback signal is input from the user terminal, music on the timeline may be played on the user terminal.

During playback of music on the user terminal, photos recommended or registered by a user or an acquaintance of the user among the multiple photos may be displayed on the user terminal.

The photo registering unit may store the photo data directly transmitted from the user terminal in a database, or store link information of the photo transmitted from the user terminal in the database, or download photo data downloaded using the link information of the photo transmitted from the user terminal and store the photo data in the database.

During playback of the music on the user terminal, a currently displayed photo may be recommended.

During playback of music on the user terminal, photo data matched to currently played music may be registered.

Other aspects, features, and advantages in addition to the above-described aspects, features, and advantages will become apparent from the drawings, claims, and the detailed description of the present invention provided below.

The general and detailed aspects may be carried out using a system, a method, a computer program, or any combination of the system, the method, and the computer program.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates a system for providing a social network service (SNS) according to an embodiment of the present invention;

FIG. 2 is a block diagram illustrating an internal structure of a service providing server of FIG. 1;

FIG. 3 illustrates a state in which a home screen provided by a system for providing an SNS according to an embodiment of the present invention is displayed on a user terminal;

FIG. 4 illustrates a state in which a music playback screen provided by a system for providing an SNS according to an embodiment of the present invention is displayed on a user terminal;

FIG. 5 illustrates a state in which a time line screen provided by a system for providing an SNS according to an embodiment of the present invention is displayed on a user terminal; and

FIG. 6 is a flowchart illustrating a method for providing an SNS according to an embodiment of the present invention.

### DETAILED DESCRIPTION

The present invention may be variously changed and particular embodiments thereof will be illustrated in the drawings and described in detail in the detailed description of the present invention. The effects and features of the present invention and methods for achieving them will become apparent by referring to the embodiments described in detail with reference to the drawings. However, the present invention may be implemented in various forms without being limited to the embodiments disclosed below. In the following embodiments, terms such as first, second, and the like can be used to describe a number of components, however, these components are not limited by these terms. The singular forms include the plural forms unless otherwise specified. In this description, the term “include” or “have” is intended to indicate that characteristics and components, elements, and the like disclosed in the specification or combinations thereof exist, and does not exclude additional possibilities of one or more other characteristics, components, elements or combinations thereof. The size and thickness of each component in the drawings are illustrated arbitrarily for convenience of description, and thus, the present invention is not limited to the illustration. Hereinafter, embodiments of the present invention will be described in detail with reference to the accompanying drawings, and like components will be referred to as like reference numerals throughout the drawings and will not be described repetitively.

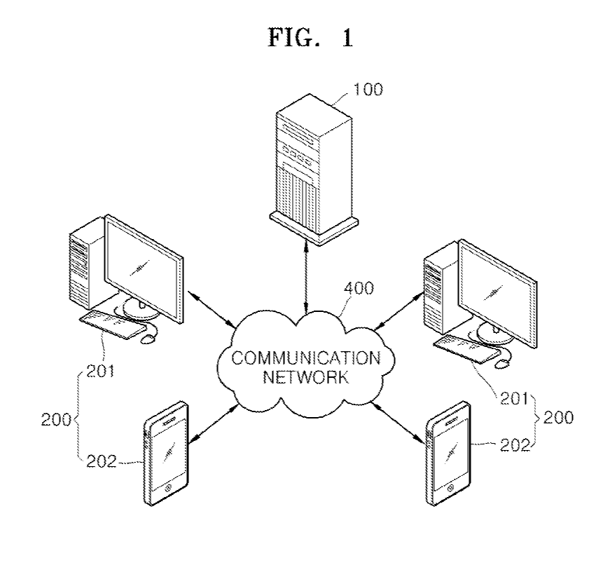

FIG. 1 illustrates a system for providing a social network service (SNS) according to an embodiment of the present invention.

Referring to FIG. 1, a system for providing an SNS according to an embodiment of the present invention may include a plurality of user terminals 200, a service providing server 100 that receives and registers photos matched to predetermined music from the user terminals 200, provides one or more photos registered to match the music to the user terminals 200 during playback of the music on the user terminals, and provides one or more posts including information about predetermined music corresponding to photos recommended or registered by a user or user's acquaintances or recommended or photos registered on a time line, and a communication network 400 that connects the plurality of user terminals 200 to the service providing server 100.

First, a social network service (SNS) provided in the present invention will be described. A service that allows a user to reinforce a human relationship with friends, seniors/juniors, and colleagues and to build a wide human network (a human relationship) while making personal contacts over the Internet is referred to as an “SNS”. This service may be called one-person media or one-person community and enables sharing personal information and helps communication over the Internet.

As self-expression desires have become stronger, an SNS for building and maintaining social relationships has also evolved. A community service such as an Internet café, a club, or the like on the web is used by a group having an interest in particular subjects to share an exclusive service, whereas an SNS is led by an individual to share his/her matter of interest and personality.

The SNS has been used mainly for social networking or entertainment purposes in its early stage, but nowadays, the SNS has been recently employed for production purposes such as business or information sharing. Many people have also searched for and used up-to-date information by using the SNS instead of surfing the Internet. Given the nature of the SNS formed mainly by acquaintances, information shared based on friends' recommendation is more reliable and is delivered more simply than information found by searches.

Using the SNS, users share information with acquaintances by uploading texts regarding their recent status or matters of interest to their timelines, sharing links for their favorite music, or uploading photos related to them or their favorite photos.

General portal sites or music portal sites provide various forms of music playback applications enabling users to listen to the music. The music playback applications provide not only a music listening function, but also information about a song, cover art photos of an album including the song, and the like, such that the user may see the cover art photos while listening to the song.

However, the conventional SNS does not provide a function for sharing the music together with a well-matched photo and the conventional music playback applications enable users to see only cover art photos while listening to music.

To solve such problems, the present disclosure provides a system and method for providing a music/photo-based SNS, wherein a user may upload a photo that is well matched to the music to which the user is listening and may also see photos uploaded by other users while listening to the music, and music and photos corresponding thereto uploaded by the user and acquaintances of the user are displayed on a timeline of a user terminal.

Referring back to FIG. 1, a plurality of user terminals 200 mean communication terminals capable of using a web service in a wired/wireless communication environment. Herein, the user terminal 200 may be a Personal Computer (PC) 201 or a portable terminal 202 of a user. Although the portable terminal 202 is illustrated as a smart phone in FIG. 1, the spirit of the present invention is not limited to this example and a terminal having installed therein an application capable of performing web browsing may be used without limitation as described above.

The communication network 400 connects the plurality of user terminals 200 with the service providing server 100. That is, the communication network 400 means a communication network for providing a connection path through which the user terminals 200 connect to the service providing server 100 to transmit and receive packet data.

The service providing server 100 receives photos matched to predetermined music from the user terminals 200, registers the received photos, provides one or more photos registered as being matched to the music to the user terminal 200 during playback of the music on the user terminal 200, and provides information about predetermined music and one or more photos registered or recommended as being matched to the music on a timeline of the user terminal 200.

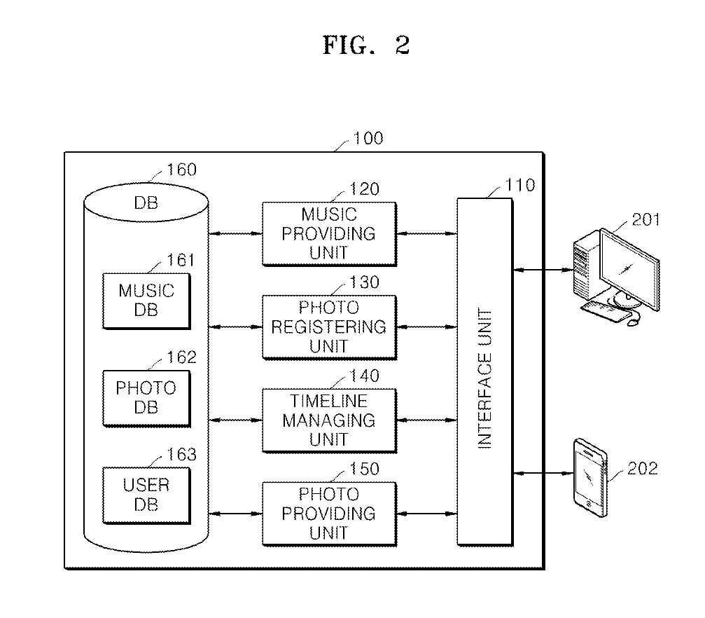

FIG. 2 is a block diagram of an internal structure of the service providing server 100 illustrated in FIG. 1.

Referring to FIG. 2, the service providing server 100 of the system for providing an SNS according to an embodiment of the present invention may include an interface unit 110, a music providing unit 120, a photo registering unit 130, a timeline managing unit 140, a photo providing unit 150, and a Database (DB) 160.

More specifically, the interface unit 110 provides a communication interface for providing transmission/reception signals between the service providing server 100 and the user terminal 200 in the form of packet data based on cooperation with the communication network 400.

The music providing unit 120 provides music data stored in a music DB 161 of the DB 160 to a music playback application running on the user terminal 200. That is, the music providing unit 120 may provide music source data and music-related information data (for example, a title, a singer, information of an album including music, album cover art photo data, and so forth) to the user terminal 200. The music source data or the music-related information data may be provided to the user terminal 200 every playback of music on the user terminal 200, or may be downloaded and stored on the user terminal 200 and may be later used for playback of the music. The music providing unit 120 is similar with a music providing unit that provides music to a music playback application provided in existing music portal sites, and thus will not be described in detail herein.

The photo registering unit 130 receives photo data matched to predetermined music which is transmitted from the user terminal 200, that is, music-matched photo data, and stores the received music-matched photo data in the DB 160. The photo data may be directly transmitted from the user terminal 200 and stored, or information such as link information of a photo may be transmitted and stored, or a photo may be downloaded using the transmitted link information of the photo and stored in the DB 160.

More specifically, the photo registering unit 130 stores a photo in a photo DB 162 of the DB 160, and in this case, information about which music data stored in the music DB 161 the photo is matched to may also be stored together with the photo. Information about a user who uploads the photo may be stored in a user DB 163 of the DB 160.

Herein, the music-matched photo data registered in the photo registering unit 130 may be photo data matched to predetermined music transmitted by a user, photo data matched to predetermined music transmitted by users who are acquaintances of the user, or photo data recommended a predetermined number of times or more or ranked in a predetermined place or higher in terms of recommendation, that is, photo data regarding a popular photo, among multiple photos registered as being matched to the predetermined music.

The timeline managing unit 140 provides one or more posts including information about predetermined music and one or more photos registered or recommended as being matched to the music to the user terminal 200 such that the posts may be displayed on the timeline of the user terminal 200. In this case, the timeline managing unit 140 may provide a post including a photo recommended or registered by the user or an acquaintance of the user and information about music matched to the photo to the user terminal 200, such that the post may be displayed on the timeline of the user terminal 200. The timeline managing unit 140 may display the photo and the information about the music matched to the photo on the timeline of the user terminal 200 in a time order of registration of posts.

The photo providing unit 150 provides one or more photos to be displayed on the user terminal 200 to the user terminal 200 when music is played on the music playback application running on the user terminal 200. The photo providing unit 150 provides multiple photos registered as being matched to the currently played music to the user terminal 200 such that the photos may be displayed on the user terminal 200 in an order of the number of recommendations. The photo providing unit 150 may also provide photos registered by the user or an acquaintance of the user to the user terminal 200 such that the photos may be displayed on the user terminal 200. Alternatively, as in a conventional technique, cover art photos of an album including music may be provided to the user terminal 200.

The DB 160 may include the music DB 161, the photo DB 162, and the user DB 163.

The music DB 161 stores music source data and music-related information data (for example, a title, a singer, information of an album including music, album cover art photo data, and so forth).

The photo DB 162 stores photos uploaded by users, and may also store information about which music data stored in the music DB 161 the photos are matched to, together with the photos. The photo DB 162 may also store identification information (for example, an identification (ID) or the like) regarding the users who upload the photos.

The user DB 163 stores user information regarding a user who desires to use an SNS. Herein, the user information may include basic information regarding a user, such as a name, title, and personal details of the user, and login information such as an ID and a password (PW).

Although not shown in the drawings, a memory, an input/output unit, a program storing unit, and a control unit may be further included in the service providing server 100 according to an embodiment of the present disclosure.

The memory temporarily stores data processed by the music providing unit 120, the photo registering unit 130, the timeline managing unit 140, and the photo providing unit 150 or data generated in a process of providing the SNS to the user terminal 200. The input/output unit displays a processing state corresponding to a key input and a processing state related to providing of the SNS.

The program storing unit has installed therein control software that executes various SNS providing operations including an operation of performing service subscription with respect to the user terminal 200 that desires to provide an SNS and storing user information regarding a user who finishes the service subscription in the user DB 163, an operation of receiving the subscriber information transmitted from the user terminal 200 that requests user authentication and determining whether the received subscriber information is identical to authentication information stored in the user DB 163, an operation of receiving and registering photos matched to predetermined music from the user terminals 200, an operation of providing one or more photos registered as being matched to music to the user terminal 200 during playback of the music on the user terminal 200, and an operation of providing a post including a photo recommended or registered by the user or an acquaintance of the user and information about music matched to the photo on the timeline of the user terminal 200.

The controller is a kind of a central processing unit and controls an overall process of providing an SNS to the user terminal 200 from the service providing server 100. That is, the controller provides various SNS functions such as driving the control software installed on the program storing unit, displaying photos matched to currently played music upon execution of a music playback application on the user terminal, and displaying a post posted by the user or an acquaintance of the user on the timeline.

As such, according to an embodiment of the present invention, various photos may be displayed for currently played music, thus providing a user who listens to the music with various pleasant feelings. Moreover, the user may share a photo matched to music and commends with his acquaintances or other people who listen to the music, thereby providing an SNS that satisfies the user's needs and thus helps in further developing the SNS.

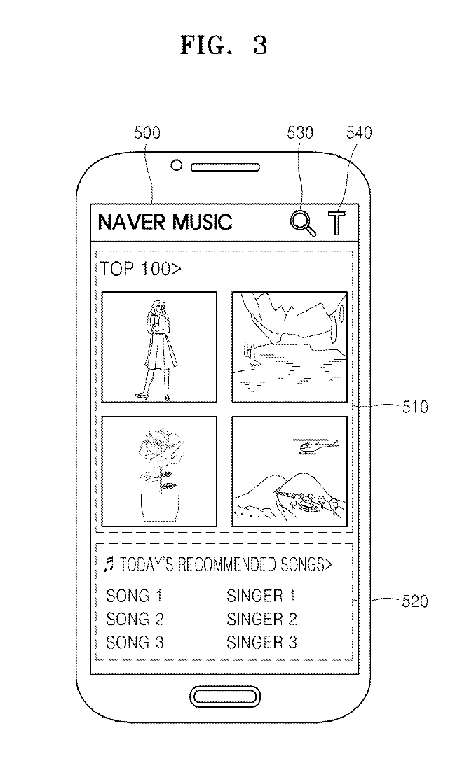

FIG. 3 illustrates a state in which a home screen provided by the system for providing an SNS according to an embodiment of the present invention is displayed on the user terminal 200. Referring to FIG. 3, on a home screen 500 provided by the system for providing an SNS according to an embodiment of the present invention, a popular music providing portion 510, a recommended music providing portion 520, a music searching button 530, and a timeline connecting button 540 are provided.

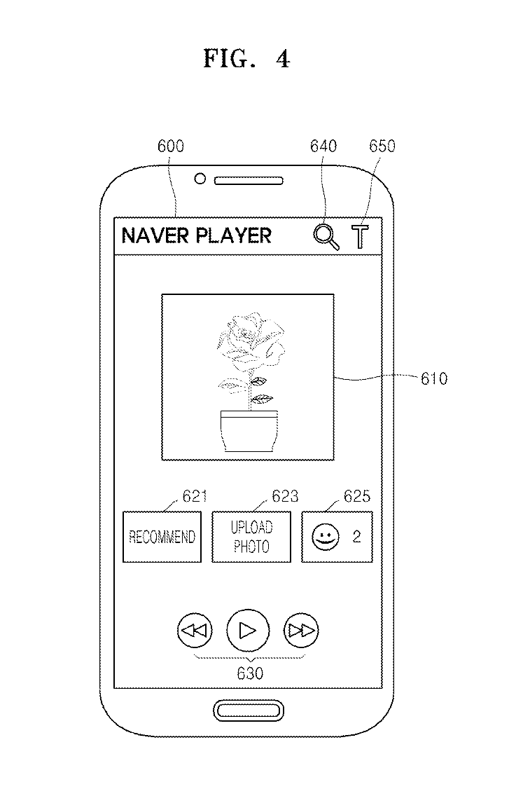

The popular music providing portion 510 provides information about music popular with the users. That is, the popular music providing unit 510 may provide titles, singers, and album cover art photos of one or more popular songs. Although information about titles, singers, and album cover art photos of four popular songs is provided in FIG. 3, the number of popular songs that are provided, an arrangement of the songs on the screen, and a type of provided information may be changed variously according to a screen configuration of the home screen 500. By clicking or touching information about music provided in the popular music providing portion 510, a music playback screen (see FIG. 4) may be provided to play the music.

The music searching button 530 provides a function of moving to a music search screen (not shown). The user searches for a song the user desires to play on the music search screen (not shown), and upon selection of the song, the user may move to the music playback screen (see FIG. 4) for playing the song.

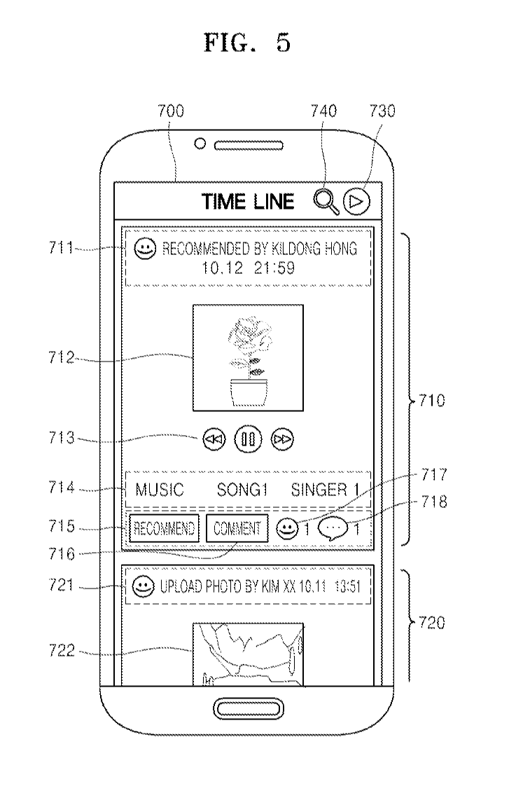

The timeline connecting button 540 provides a function of moving to a timeline screen (see FIG. 5). By clicking or touching the timeline connecting button 540, the user may move to the timeline screen that displays a photo recommended or registered by the user or an acquaintance of the user and information about a song matched to the photo.

FIG. 4 illustrates a state in which the music playback screen provided by the system for providing an SNS according to an embodiment of the present invention is displayed on the user terminal 200. Referring to FIG. 4, on a music playback screen 600 provided by the system for providing an SNS according to an embodiment of the present disclosure, a photo display portion 610, a playback control portion 630, a music searching button 640, and a timeline connecting button 650 may be provided.

The photo display portion 610 displays one or more photos matched to currently played music. In this case, multiple photos registered as being matched to the currently played music may be displayed on the photo display portion 610 in an order of the number of recommendations (a popular photo mode). Photos registered or recommended by the user or an acquaintance of the user may be displayed from among the multiple photos registered as being matched to the currently played music (a social photo mode). Cover art photos of an album including the currently played music may be displayed (an album mode).

Herein, multiple photos may be sequentially displayed on the photo display portion 610 by automatic sliding at predetermined time intervals. The user may arbitrarily set the slide time intervals. The user may also sequentially see the multiple photos by performing a flicking motion on the screen to the left or to the right.

Outside of the photo display portion 610, a recommendation button 621, a photo upload button 623, and a number-of-recommendations display portion 625 are provided.

The recommendation button 621 provides a function of recommending a currently displayed photo. If the user clicks or touches the recommendation button 621, the number of recommendations for the photo increases, and at the same time, a post including the photo and information about music matched to the photo may be displayed on a timeline of the user and timelines of acquaintances of the user.

The photo upload button 623 provides a function of allowing the user to register a photo matched to the currently played music in the service providing server 100. If the user selects the photo upload button 623 to upload a photo, the photo is stored in the photo DB 162 of the service providing server 100. In this case, photo data stored in the user terminal 200 may be directly transmitted to and stored in the service providing server 100. Information such as link information of the photo may also be transmitted from the user terminal 200 to the service providing server 100 and may be stored in the service providing server 100, or a photo may be downloaded from the photo registering unit 130 of the service providing server 100 by using the transmitted link information of the photo and may be stored in the DB 160. In this case, information about which music data stored in the music DB 161 is matched to the photo may also be stored together. Information about the user who uploads the photo may have been stored in the user DB 163 of the DB 160. Once the photo is uploaded, a post including the photo and information about music matched to the photo may be displayed on a timeline of the user and on timelines of acquaintances of the user.

The number-of-recommendations display portion 625 provides a function of displaying the number of recommendations for a currently displayed photo.

The playback control portion 630 includes a play/stop button, a next button, and a back button to control play, stop, and move functions for music. The playback control portion 630 is similar with a conventional music playback application, and thus will not be described in detail.

The music searching button 640 provides a function of moving to a music search screen (not shown). The user searches for music to be played on the music search screen (not shown) and upon selection, moves to a music playback screen (see FIG. 4) for playing the music.

The timeline connecting button 650 provides a function of moving to a timeline screen (see FIG. 5). The user may move to the timeline screen displaying a post including a photo recommended or registered by the user or acquaintances of the user and information about music matched to the photo by clicking or touching the timeline connecting button 650.

FIG. 5 illustrates a state in which the timeline screen provided by the system for providing an SNS according to an embodiment of the present invention is displayed on the user terminal 200. Referring to FIG. 5, one or more post display portions 710 and 720, a timeline playback button 730, and a music search button 740 may be provided on a timeline screen 700 provided by the system for providing an SNS according to an embodiment of the present invention. Posts including photos recommended or registered by the user or acquaintances of the user and information about music matched to the photos are displayed on the post display portions 710 and 720.

The respective post display portions 710 and 720 may include a post information display portion 711, a photo display portion 712, a playback control portion 713, a music information display portion 714, a recommendation button 715, a comment button 716, a number-of-recommendations display portion 717, and a number-of-comments display portion 718.

On the post information display portion 711, an author and a posted time of a post may be displayed. A photo recommended or registered by the user or acquaintances of the user may be displayed on the photo display portion 712. The playback control portion 713 includes a play/stop button, a next button, and a back button to control play, stop, and move functions for music. Information such as a title and a singer of music may be displayed on the music information display portion 714.

The recommendation button 715 provides a function of recommending a currently displayed photo. If the user clicks or touches the recommendation button 715, the number of recommendations for a photo increases, and at the same time, on timelines of the acquaintances of the user, a post including a photo and information about music matched to the photo is displayed. The number-of-recommendations display portion 717 provides a function of displaying the number of recommendations for a post.

The comment button 716 provides a function of allowing the user to leave a comment on a post, and the number-of-comments display potion 718 provides a function of displaying the number of comments left for a post. The comment button 716 and the number-of-comments display portion 718 are similar with an existing SNS and thus will not be described in detail.

One or more posts may be displayed on the timeline screen 700, and the posts may be displayed in an order of time in which they are posted. The user may read posts by pushing the screen up and down or the user may sequentially view multiple posts by flicking the screen up and down or to the left and to the right.

The timeline playback button 730 generates a predetermined playlist for songs of a post posted on the timeline of the user and sequentially plays the songs of the playlist. Although not shown in the drawings, filtering may be provided for one or more posts posted on the timeline to enable the user to edit a playlist.

The music search button 740 provides a function of moving to the music search screen (not shown). The user searches for music to be played on the music search screen (not illustrated), and upon selection, moves to the music playback screen (see FIG. 4) for playing the music.

Herein, registration and confirmation of a photo described above may also be performed on a single application or separately performed on several applications (for example, a photo registering application, a music playback application, and a timeline application).

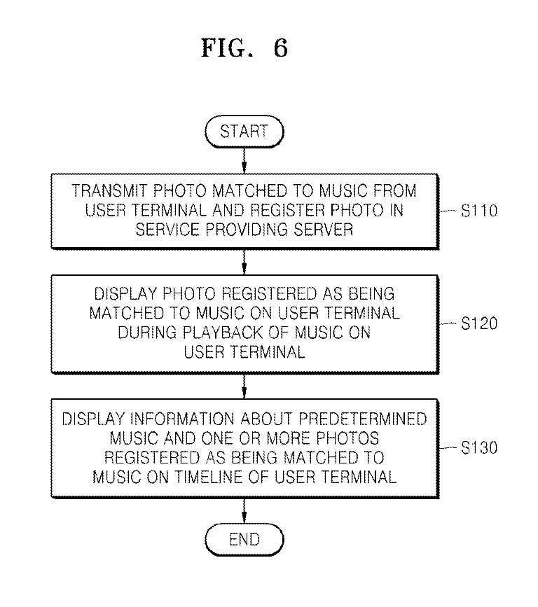

FIG. 6 is a flowchart illustrating a method for providing an SNS according to an embodiment of the present disclosure. Referring to FIG. 6, a method for providing an SNS according to an embodiment of the present invention includes operation S110 of transmitting photo data matched to predetermined music from a user terminal 200 and registering the photo data in a service providing server 100, operation S120 of providing one or more photos registered as being matched to music to the user terminal during playback of the music to allow the one or more photos to be displayed on the user terminal, and operation S130 of providing one or more posts including photos recommended or registered by a user or an acquaintance of the user and information about music matched to the photos to the user terminal to allow the posts to be displayed on a timeline of the user terminal. The method will be described in more detail below.

In operation S110, photo data matched to predetermined music is transmitted from the user terminal 200 and registered in the service providing server 100. That is, while listening to the music on the music playback screen shown in FIG. 4, the user may select the photo upload button 623 to register a photo matched to the currently played music in the service providing server 100. If the user selects the photo upload button 623 to upload a photo, the photo is stored in the photo DB 162 of the service providing server 100. In this case, photo data stored in the user terminal 200 may be directly transmitted to and stored in the service providing server 100. Link information of a photo may be transmitted from the user terminal 200 to the service providing server 100 and may be stored in the service providing server, or a photo may be downloaded from the photo registering unit 130 of the service providing server 100 by using the transmitted link information of the photo and may be stored in the DB 160. At this time, information about which music data stored in the music DB 161 the photo is matched to may also be stored together with the photo in the music DB 161, and information about the user who uploads the photo may be stored in the user DB 163 of the DB 160.

Next, one or more photos registered as being matched to music are provided to the user terminal 200 during playback of the music on the user terminal to allow the photos to be displayed on the user terminal in operation S120. That is, the user listens to the music on the music playback screen shown in FIG. 4, and at this time, one or more photos matched to the currently played music are displayed on the photo display portion 610. Herein, on the photo display portion 610, multiple photos registered as being matched to the currently played music may be displayed in an order of the number of recommendations (a popular photo mode). Among the multiple photos registered as being matched to the currently played music, photos registered or recommended by the user or acquaintances of the user may be displayed (a social photo mode). Cover art photos of an album including the currently played music may be displayed (an album mode).

Herein, multiple photos may be sequentially displayed on the photo display portion 610 by automatic sliding at predetermined time intervals. The user may arbitrarily set the slide time intervals. The user may also sequentially view the multiple photos by flicking the screen to the right and to the right.

When the user selects the timeline connecting button 540 on the home screen 500 (shown in FIG. 3) or the timeline connecting button 650 on the music playbook screen 600 (shown in FIG. 4), one or more posts including photos recommended or registered by the user or the acquaintances of the user and information about music matched to the photos are provided to the user terminal 200 to allow the posts to be displayed on the timeline of the user terminal in operation S130. That is, on the timeline screen 700 shown in FIG. 5, posts including photos recommended or registered by the user or the acquaintances of the user and information about music matched to the photos are displayed.

One or more posts may be displayed on the timeline screen 700 and may be displayed in an order of time in which they are posted. The user may read the posts by pushing the screen up and down or may sequentially view multiple posts by flicking the screen up and down or to the left and to the right.

The timeline playback button 730 provided on the timeline screen 700 provides a function of generating a playlist for songs of a post posted on the user's timeline and sequentially playing the songs of the playlist. In this case, filtering may be provided for one or more posts posted on the timeline to allow the user to edit the playlist.

According to an embodiment of the present invention, various photos may be displayed for currently played music, thus providing various pleasures to the user listening to the music. Moreover, the user shares photos matched to music and comments with acquaintances or persons listening to the same music, such that an SNS satisfying the users' needs may be provided and thus the SNS may be further activated.

As described above, according to the one or more of the above embodiments of the present invention, an SNS which meets user's needs is provided by the system and method for providing a music/photo-based SNS.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A method for providing a social network service (SNS) to share predetermined data between users who are acquaintances of each other, the method comprising:
Transmitting, by a service providing server, music-matched photo data from one or more user terminals to a service providing server;
registering the music-matched photo data in the service providing server; and
providing one or more music-matched photo data matched to the currently played music to the user terminal of the user during playback of music on the user terminal of the user to display the photo data on the user terminal of the user;
wherein the music-matched photo data provided to the user terminal comprises one or more of:
music-matched photo data transmitted from a user terminal of a user;
music-matched photo data transmitted from a user terminal of at least one acquaintance of the user; and
music-matched photo data recommended a predetermined number of times or more or ranked in a predetermined place or higher in terms of recommendation among photo data registered.

2. The method of claim 1, further comprising:
providing one or more posts including a photo recommended or registered by the user or the at least one acquaintance of the user and information about music matched to the photo to the user terminal of the user to display the posts on a timeline of the user terminal of the user.

3. The method of claim 1, wherein the displaying of the photo data during playback of the music comprises sequentially displaying the multiple photos on the user terminal of the user during playback of music, if the multiple photos matched to the music exist.

4. The method of claim 3, wherein the multiple photos are displayed in an order of the number of recommendations.

5. The method of claim 3, wherein photos recommended or registered by the user or the at least one acquaintance of the user from among the multiple photos are displayed.

6. The method of claim 2, wherein, if a timeline playback signal is input from the user terminal of the user, music on the timeline is played on the user terminal of the user.

7. The method of claim 6, wherein, during playback of music on the user terminal of the user, photos recommended or registered by the user or the at least one acquaintance of the user from among the multiple photos are displayed.

8. The method of claim 1, wherein during playback of music on the user terminal of the user, a currently displayed photo can be recommended to be the music-matched photo data.

9. The method of claim 1, wherein during playback of music on the user terminal of the user, photo data matched to the currently played music is registered at the service providing server.

10. The method of claim 9, wherein the photo data is directly transmitted from the user terminal of the user and registered in the service providing server, or
link information of a photo is transmitted from the user terminal of the user and the link information of the photo or photo data downloaded using the link information of the photo is registered in the service providing server.

11. A system for providing a social network service (SNS) to share predetermined data between users who are acquaintances of each other, the system comprising:
a music providing unit providing music data to be played on a user terminal;
a photo registering unit registering music-matched photo data transmitted from at least one user terminal in a service providing server; and
a photo providing unit providing one or more music-matched photo data to the user terminal of the user during playback of music on the user terminal of the user,
wherein the music-matched photo data provided to the user terminal comprises one or more of:
music-matched photo data transmitted from a user terminal of a user;
music-matched photo data transmitted from a user terminal of at least one acquaintance of the user; and
photo data recommended a predetermined number of times or more or ranked in a predetermined place or higher in terms of recommendation among photo data registered.

12. The system of claim 11, further comprising:
a timeline managing unit providing one or more posts including at least one photo recommended or registered by the user or the at least one acquaintance of the user and information about music matched to the photo to the user terminal.

13. The system of claim 11, wherein if multiple photos matched to music exist, the photo providing unit provides the photos to the user terminal of the user during playback of the music to allow the multiple photos to be sequentially displayed on the user terminal of the user.

14. The system of claim 13, wherein the multiple photos are displayed on the user terminal of the user in an order of the number of recommendations.

15. The system of claim 13, wherein photos recommended or registered by the user or the at least one acquaintance of the user among the multiple photos are displayed on the user terminal of the user.

16. The system of claim 12, wherein when a timeline playback signal is input from the user terminal of the user, music on the timeline is played on the user terminal of the user.

17. The system of claim 16, wherein during playback of music on the user terminal of the user, photos recommended or registered by the user or the at least one acquaintance of the user among the multiple photos are displayed on the user terminal of the user.

18. The system of claim 11, wherein the photo registering unit stores the photo data directly transmitted from the user terminal of the user in a database, or
stores link information of the photo transmitted from the user terminal of the user in the database, or downloads photo data downloaded using the link information of the photo transmitted from the user terminal of the user and stores the photo data in the database.

19. The system of claim 11, wherein during playback of the music on the user terminal of the user, a currently displayed photo can be recommended to be the music-matched photo data.

20. The system of claim 11, wherein during playback of music on the user terminal of the user, photo data matched to currently played music is registered at the photo registering unit.
